(19) United States
(12) Patent Application Publication
(10) Pub. No.: US 2006/0209001 A1
(43) Pub. Date: Sep. 21, 2006

(54) Liquid crystal display (LCD) device and method of driving LCD

(76) Inventor: Soon-Wook Kwon, Suwon-si (KR)

Correspondence Address: Robert E. Bushnell, Suite 300, 1522 K Street, N.W., Washington, DC, 20005, US

(21) Appl. No.: 11/287,201

(22) Filed: Nov. 28, 2005

(30) Foreign Application Priority Data
Dec. 10, 2004 (KR) 2004-104479

(51) Int. Cl. G09G 3/36

(52) U.S. Cl. 345/102

(57) ABSTRACT

In a Liquid Crystal Display (LCD) device having an Optically Compensated Bend (OCB) mode liquid crystal and a method of driving the device, a source driver applies a transition pulse wave voltage to a pixel electrode of the liquid crystal for a predetermined time duration. The pulse wave voltage is 5 to 7 volts at maximum, and has a frequency of 100 to 500 Hz. Accordingly, since there is no need for a DC-DC converter to apply a high voltage and since a low initial bend transition voltage is used, the manufacturing costs and power consumption are reduced.

### CLAIM OF PRIORITY

This application makes reference to, incorporates the same herein, and claims all benefits accruing under 35 U.S.C. §119 from an application for LIQUID CRYSTAL DISPLAY DEVICE AND METHOD OF DRIVING THE SAME earlier filed in the Korean Intellectual Property Office on Dec. 10, 2004 and there duly assigned Serial No. 2004-104479.

### BACKGROUND OF THE INVENTION

1. Field of the Invention

The present invention relates to a Liquid Crystal Display (LCD) device, and more particularly, to an LCD device which supplies a pulse wave voltage to quicken a bend transition of a liquid crystal in an LCD device having an Optically Compensated Bend (OCB) mode, and to a method of driving the LCD.

2. Description of the Related Art

An LCD device is thin, lightweight, and low in power consumption compared to a Cathode Ray Tube (CRT), and has also less electromagnetic wave emission. Thus, LCD devices have been widely used as displays of portable information devices such as cellular phones, computers, and Personal Digital Assistants (PDAs).

However, the LCD device has different brightness and color according to the angle at which it is observed and has a narrow viewing angle. Various ways of resolving this viewing angle problem have been suggested.

For example, in order to improve the viewing angle range of the LCD device, a technique that arranges a prism plate on a light guide panel to improve straightness of light emitted from a back light, so that brightness in a vertical direction is improved more than 30%, has been put into practice. Also, a technique that provides a negative compensation film to improve viewing angle range is being employed.

Furthermore, an In Plane Switching mode has been developed to achieve a wide viewing angle of 160°, which is almost the same as that of a CRT. However, this method has a low aperture ratio and thus needs further improvement.

Moreover, in order to improve the viewing angle range, TFT driving techniques including an Optically Compensated Bend (OCB) mode, a Polymer Dispersed Liquid Crystal (PDLC) mode, a Deformed Helix Ferroelectric (DHF) mode, and so on, have been suggested.

In particular, the OCB method has been the focus of considerable research and development efforts because it has a fast liquid crystal response speed and a wide viewing angle.

As to the operation of an OCB mode, an initial alignment state of a liquid crystal arranged between an upper plate electrode and a lower plate electrode is a homogeneous state, and when a predetermined voltage is supplied across the upper and lower plate electrodes, a state of the liquid crystal changes via a transient splay and an asymmetric splay into a bend state and then operates in an OCB mode.

An OCB liquid crystal cell typically has a tilt angle of about 10° to 20°, a thickness of about 4 μm to 7 μm, and an alignment layer is rubbed in the same direction.

Liquid crystal molecules in a central portion of a liquid crystal layer are left-and-right symmetrically arranged, and thus a tilt angle is 0° at less than a predetermined voltage and 90° at more than the predetermined voltage. A high voltage is initially supplied, so that the tilt angle of the liquid crystal molecules in the central portion of the liquid crystal layer becomes 90°, and then the supplied voltage is varied to change the tilt angle of liquid crystal molecules not in the central portion of the liquid crystal layer, thereby modulating the polarization of light passing through the liquid crystal layer.

It takes tens of seconds to arrange the tilt angle of the liquid crystal molecules in the central portion from 0° to 90°, and a response time is as fast as 10 since there is no back flow and it is bending transformation of a large elastic modulus.

In general, when the OCB mode is in an ON state, conversion from the transient splay to the asymmetric splay is fast, and conversion from the transient splay to the bend state is relatively fast, but conversion from the asymmetric splay to the bend state is slow.

When the OCB mode is in an OFF state, conversion from the bend state to the homogeneous state is slow but conversion from the transient splay to the homogeneous state or from the asymmetric splay to the homogeneous state is fast.

With regard to the transition time T versus transition voltage Vt for bend alignment of a liquid crystal, if the transition time T is long, a standby time required to display a screen is longer, and power consumption is increased since a supplied voltage is high during the transition time T. If the transition voltage Vt is high, power consumption is high, and a power source having a high capacity is needed.

As described above, a predetermined time, i.e., the transition time T, is spent to get the bend alignment for the OCB mode. In order to reduce the transition time T, a high voltage must be supplied to both terminals of the liquid crystal.

In order to shorten the transition time for the initial bend transition, a DC transition voltage Vt is initially supplied during the transition time T, and then a data voltage having a waveform corresponding to an image signal is supplied to display an image during a screen display period. If the transition voltage Vt is increased as described above, it is expected that the transition time T is shortened, but since the LCD device has a fine structure, it is impossible to supply a voltage which exceeds a withstandable voltage between the terminals of the Liquid Crystal (LC) capacitor. Also, in order to supply a high voltage, a corresponding power source is needed. When the LCD device is used as a monitor of a portable terminal, this increases the size of the portable terminal.

The LCD device described above typically supplies a high voltage of more than 15 volts to both terminals of the liquid crystal for a fast initial bend transition. As a power source for supplying the high voltage, a source driver can be used to supply a data voltage using the existing LCD module, or a DC voltage supply circuit such as a DC-DC converter can be additionally provided to supply a high voltage to a common electrode.

However, when a high voltage is supplied from the source driver, an insulated design capable of enduring the high voltage is needed. The existing source driver is typically designed to endure a voltage of about 5.5 volts. However, since a high voltage of more than 15 volts is needed for the initial bend transition, a voltage-withstanding structure must be considered when the source driver is designed, which increases source driver volume and manufacturing cost.

Also, when a high voltage is supplied to the common electrode, a separate wire line for supplying the high voltage is needed, which complicates a manufacturing process. Since the DC voltage supplying circuit, such as the DC-DC converter, must be additionally provided, manufacturing cost increases as well.

### SUMMARY OF THE INVENTION

The present invention provides an LCD device which can shorten a transition time by supplying a pulse wave voltage as an initial voltage for a bend transition of an OCB mode liquid crystal, and a method of driving the device.

In one exemplary embodiment of the present invention, a Liquid Crystal Display (LCD) device is provided, the device including: a Liquid Crystal Display (LCD) panel including a plurality of pixel circuits arranged at crossing portions of a plurality of scan lines and a plurality of data lines, each pixel circuit having a Liquid Crystal (LC) capacitor including a common electrode, a pixel electrode, and a liquid crystal; a scan driver for applying a gate voltage to select the plurality of pixel circuits via the plurality of scan lines; a source driver for applying a data voltage to the plurality of pixel circuits via the plurality of data lines; a backlight for for emitting a to the LCD panel; a backlight controller for applying a backlight voltage to the backlight; and a timing controller for applying control signals to control the scan driver, the data driver, and the backlight controller; wherein the source driver applies a transition pulse wave voltage to the plurality of pixel circuits for a predetermined time duration in an initial driving stage.

In another exemplary embodiment of the present invention, a method of driving a Liquid Crystal Display (LCD) device including: a plurality of pixel circuits each having an LC capacitor comprised of a pixel electrode, a common electrode, and a liquid crystal; an LCD panel having the plurality of pixel circuits arranged at crossing points of a plurality of scan lines and a plurality of data lines; a scan driver applying a gate voltage to the plurality of pixel circuits, a source driver applying a data voltage to the plurality of pixel circuits, and a backlight controller applying a driving voltage to a backlight arranged on a rear portion of the LCD panel, the method comprising: outputting a transition pulse wave voltage from the source driver for a predetermined time duration; outputting the data voltage from the source driver after the passage of the predetermined duration; and emitting light of the backlight to the LCD panel.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a view of states of a liquid crystal to describe the operation of an OCB mode;

FIG. 2 is a graph of transition time versus transition voltage for bend alignment of a liquid crystal;

FIG. 3 is a graph of voltage supplied to the liquid crystal of an LCD device versus time;

FIG. 4 is a block diagram of an LCD device which rapidly achieves initial bend alignment by using a low pulse wave voltage according to an embodiment of the present invention;

FIG. 5 is a circuit diagram of one representative pixel circuit among N×M pixel circuits in an LCD device according to an embodiment of the present invention;

FIG. 6 is a graph of voltage supplied across the liquid crystal of an LCD device of the present invention versus time, illustrating a procedure of driving the liquid crystal of the LCD device according to an embodiment of the present invention;

FIGS. 7A and 7B are photographs of state variations of the liquid crystal when a transition pulse wave voltage and a transition DC voltage are supplied to an LCD device according to an embodiment of the present invention; and

FIG. 8 is a photograph of state variations of the liquid crystal according to the application of a transition voltage for a bend transition of the liquid crystal.

### DETAILED DESCRIPTION OF THE INVENTION

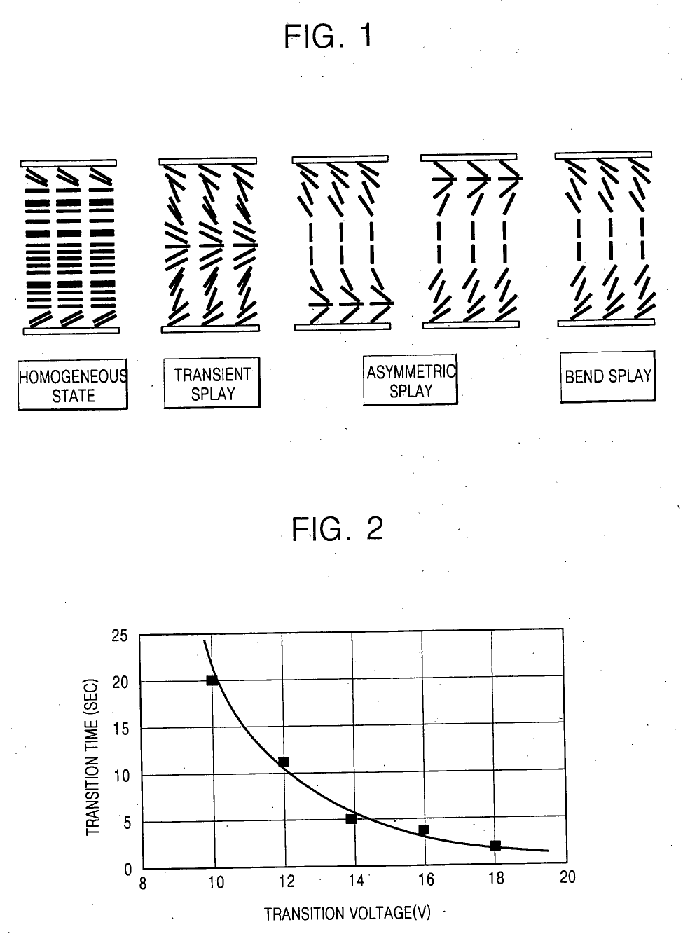

FIG. 1 is a view of states of a liquid crystal to describe the operation of an OCB mode.

Referring to FIG. 1, an initial alignment state of a liquid crystal arranged between an upper plate electrode and a lower plate electrode is a homogeneous state, and when a predetermined voltage is supplied across the upper and lower plate electrodes, a state of the liquid crystal changes via a transient splay and an asymmetric splay into a bend state and then operates in an OCB mode.

As shown in FIG. 1, an OCB liquid crystal cell has a tilt angle of about 10° to 20°, a thickness of about 4 μm to 7 μm, and an alignment layer is rubbed in the same direction.

Liquid crystal molecules in a central portion of a liquid crystal layer are left-and-right symmetrically arranged, and thus a tilt angle is 0° at less than a predetermined voltage and 90° at more than the predetermined voltage. A high voltage is initially applied, so that the tilt angle of the liquid crystal molecules in the central portion of the liquid crystal layer becomes 90°, and then the applied voltage is varied to change the tilt angle of liquid crystal molecules not in the central portion of the liquid crystal layer, thereby modulating the polarization of light passing through the liquid crystal layer.

It takes tens of seconds to arrange the tilt angle of the liquid crystal molecules in the central portion from 0° to 90°, and a response time is as fast as 10 since there is no back flow and it is bending transformation of a large elastic modulus.

In general, when the OCB mode is in an ON state, conversion from the transient splay to the asymmetric splay is fast, and conversion from the transient splay to the bend state is relatively fast, but conversion from the asymmetric splay to the bend state is slow.

When the OCB mode is in an OFF state, conversion from the bend state to the homogeneous state is slow but conversion from the transient splay to the homogeneous state or from the asymmetric splay to the homogeneous state is fast.

FIG. 2 is a graph of transition time T versus transition voltage Vt for bend alignment of a liquid crystal.

In order to guarantee a bend transition of the liquid crystal, values of the transition voltage Vt and the transition time T should lie above a solid curve of FIG. 2. If the transition time T is long, a standby time required to display a screen is longer, and power consumption is increased since a applied voltage is high during the transition time T. If the transition voltage Vt is high, power consumption is high, and a power source having a high capacity is needed. Thus, it is best to set the transition voltage Vt and the transition time Vt around the solid line. For example, if the transition voltage Vt is set to 15 volts, the transition is effected within 5 seconds.

As described above, a predetermined time, i.e., the transition time T, is spent to get the bend alignment for the OCB mode. In order to reduce the transition time T, as shown in FIG. 2, a high voltage must be applied to both terminals of the liquid crystal.

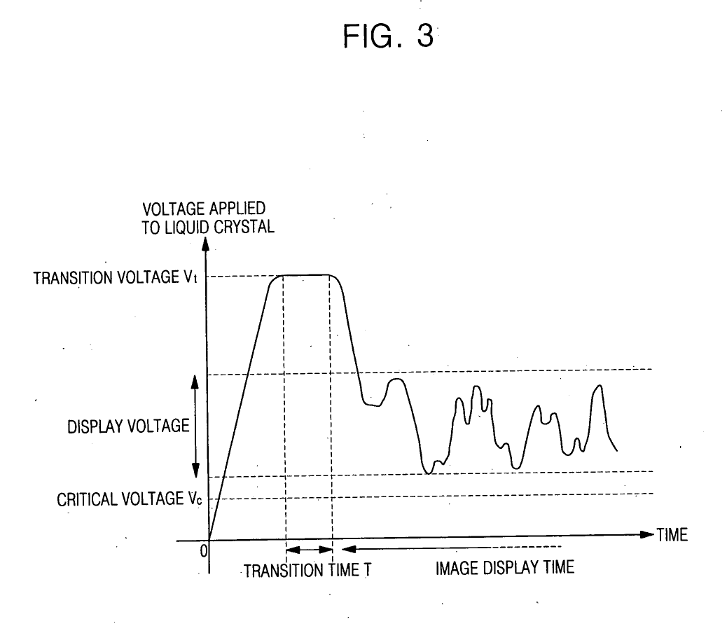

FIG. 3 is a graph of voltage applied to both terminals of the liquid crystal of the LCD device versus time.

Referring to FIG. 3, in order to shorten the transition time for the initial bend transition, a DC transition voltage Vt of about 15 volts is initially applied during the transition time T, and then a data voltage having a waveform corresponding to an image signal is applied to display an image during a screen display period. If the transition voltage Vt is increased as described above, it is expected that the transition time T is shortened, but since the LCD device has a fine structure, it is impossible to apply a voltage which exceeds a withstandable voltage between the terminals of the Liquid Crystal (LC) capacitor. Also, in order to apply a high voltage, a corresponding power source is needed. When the LCD device is used as a monitor of a portable terminal, this increases the size of the portable terminal. Thus, supplying a voltage of more than 20 volts is not realistic, and a transition time of at least one second is needed.

The present invention will now be described more fully with reference to the accompanying drawings, in which embodiments of the present invention are shown.

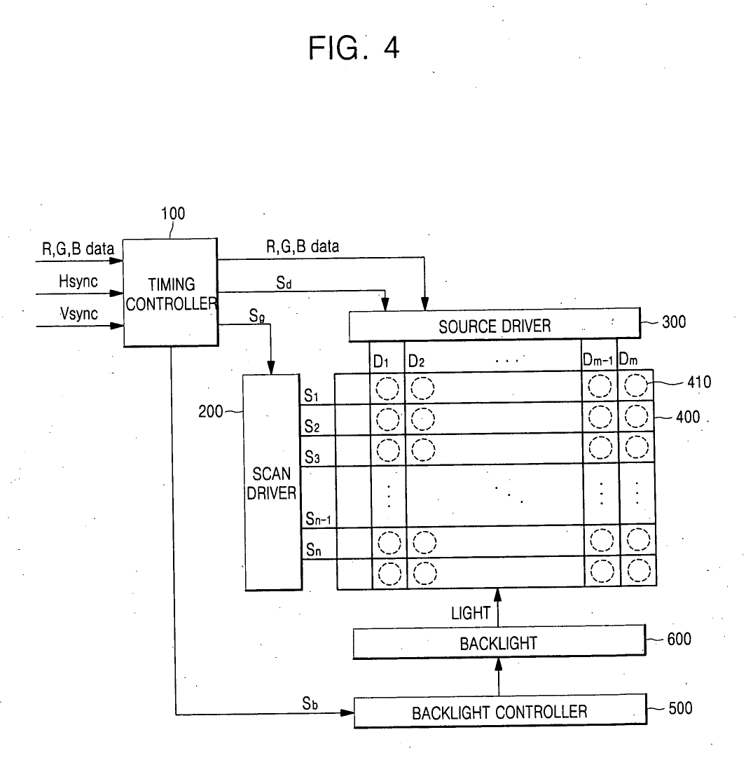

FIG. 4 is a block diagram of an LCD device which rapidly achieves initial bend alignment by using a low pulse wave voltage according to an embodiment of the present invention.

Referring to FIG. 4, the LCD device of the present invention includes a timing controller 100, a scan driver 200, a source driver 300, an LCD panel 400, a backlight controller 500, and a backlight 600.

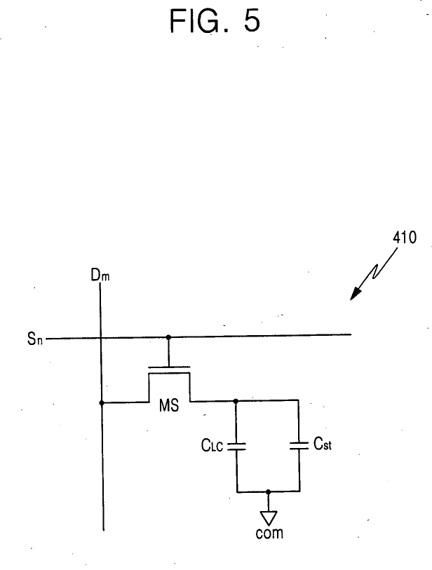

The LCD panel 400 includes a plurality of pixel circuits 410 formed at crossing points of a plurality of scan lines S1 to Sn and a plurality of data lines D1 to Dm. The pixel circuits 410 are explained below with reference to FIG. 5.

FIG. 5 is a circuit diagram of one representative pixel circuit among N×M pixel circuits in the LCD device of an embodiment of the present invention.

Referring to FIG. 5, each pixel circuit 410 includes a switching transistor MS, an LC capacitor C_{LC}, and a storage capacitor Cₛₜ. A source of the switching transistor MS is connected to the data line Dm, and a gate of the switching transistor MS is connected to the scan line Sn. The switching transistor MS is turned on in response to a gate voltage and transmits a data voltage to the LC capacitor C_{LC}. The LC capacitor C_{LC} is comprised of a pixel electrode, a common electrode COM, and an OCB mode LC layer between the pixel electrode and the common electrode, and the data voltage transmitted via the switching transistor MS is applied to the pixel electrode. The storage capacitor Cₛₜ is connected in parallel to the LC capacitor C_{LC} to store the data voltage during a predetermined time period. When the switching transistor MS is turned on at an initial stage of driving the LCD device for the bend transition of the OCB mode liquid crystal, a transition pulse wave voltage is applied to the pixel electrode via the data line Dm, so that the liquid crystal undergoes a bend transition. After the bend transition has been completed, a data voltage for image display is applied via the data line Dm.

Referring back to FIG. 4, the LCD panel 400 is driven such that the scan driver 200 applies a gate voltage via a plurality of scan lines S1 to Sn and the source driver 300 applies a data voltage to a corresponding pixel via a plurality of data lines D1 to Dm.

The scan driver 200 continuously applies the gate voltage via the plurality of scan lines S1 to Sn, and the source driver 300 applies the transition pulse wave voltage via the plurality of data lines D1 to Dm until the initial bend transition has been completed. The transition pulse wave voltage can be generated by turning a predetermined voltage ON and OFF at predetermined time intervals. The predetermined voltage can be in the range of 5 to 7 volts in the case of the currently available source driver 300. Therefore, as the transition pulse wave voltage having a magnitude lower than usual is applied at the initial driving stage of the liquid crystal molecules of the OCB mode, the liquid crystal molecules in the central portion of the liquid crystal layer can be rapidly tilted to an angle of 90°.

At the initial driving stage of the LCD device, the timing controller 100 applies control signals Sd and Sg which control the scan driver 200 and the source driver 300 such that a predetermined voltage, e.g., 5 to 7 volts, is applied to the pixel electrode until the liquid crystal has fully undergone the bend transition. After the bend transition of the liquid crystal, the timing controller 100 applies the control signals Sd and Sg such that the scan driver 200 and the source driver 300 output a gate voltage for selecting a pixel circuit and a data voltage for displaying an image. The timing controller 100 applies the backlight controller 500 with a backlight control signal Sb for driving the backlight 600 after the bend transition of the liquid crystal has been completed.

The backlight controller 500 applies a predetermined voltage for driving the backlight 600 arranged at a rear portion of the LCD panel 400 according to the backlight control signal Sb applied from the timing controller 100. The backlight 600 can be comprised of a red LED, a green LED, and a blue LED, which sequentially output red light, green light, and blue light, in the field-sequential driving method, or a white LED or a Cold Cathode Fluorescent Lamp (CCFL) which outputs white light, in a driving method using a color filter. When the LCD device is driven using the color filter, color filters of red, green, and blue are arranged on the common electrode for each pixel.

As described above, the LCD device uses the source driver 300 to apply the transition pulse wave voltage of 5 to 7 volts for rapid bend transitioning of the liquid crystal at the initial driving stage, and thus there is no need for a DC-DC converter to apply a high voltage. Accordingly, manufacturing costs and power consumption are reduced.

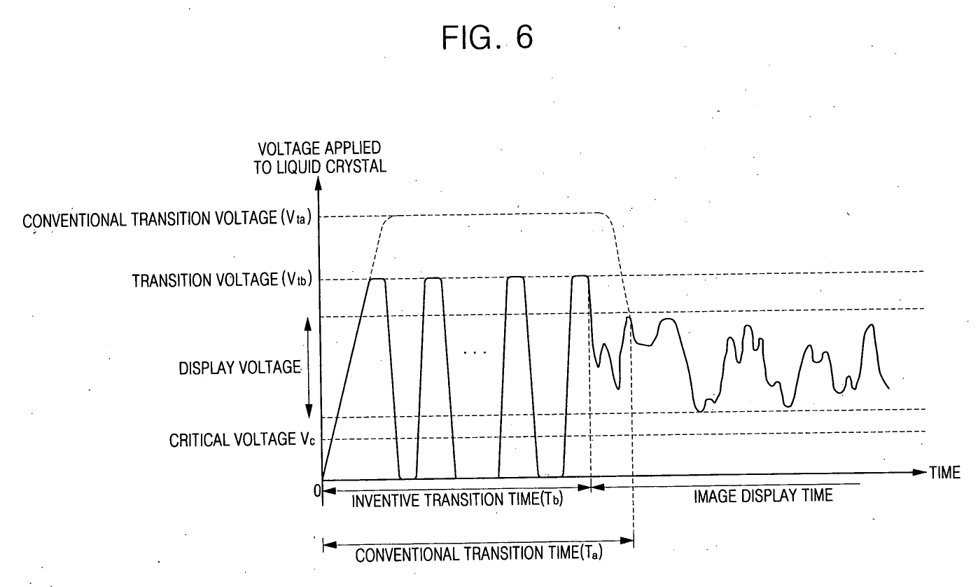

FIG. 6 is a timing diagram of a procedure of driving a liquid crystal of an LCD device according to an embodiment of the present invention.

Referring to FIG. 6, in the LCD device of the present invention, for the bend transition of the liquid crystal at the initial driving stage, the source driver 300 applies a pulse wave voltage having a predetermined frequency as the transition voltage Vtb to the pixel electrode via the data lines D1 to Dm during the transition time Th. A peak voltage of the pulse wave voltage relates to a maximum output of the source driver 300 and is preferably in the range of 5 to 7 volts. After the bend transition of the liquid crystal has been completed, a data voltage waveform corresponding to a normal image signal is applied during an image display period, and the backlight is driven to display the image signal. As shown in FIG. 6, the LCD device of the present invention provides a transition time Th that is shorter than the usual transition time Ta since a transition pulse wave voltage Vtb which is lower than a high DC voltage Vta is applied to both terminals of the liquid crystal for the initial bend transition of the liquid crystal.

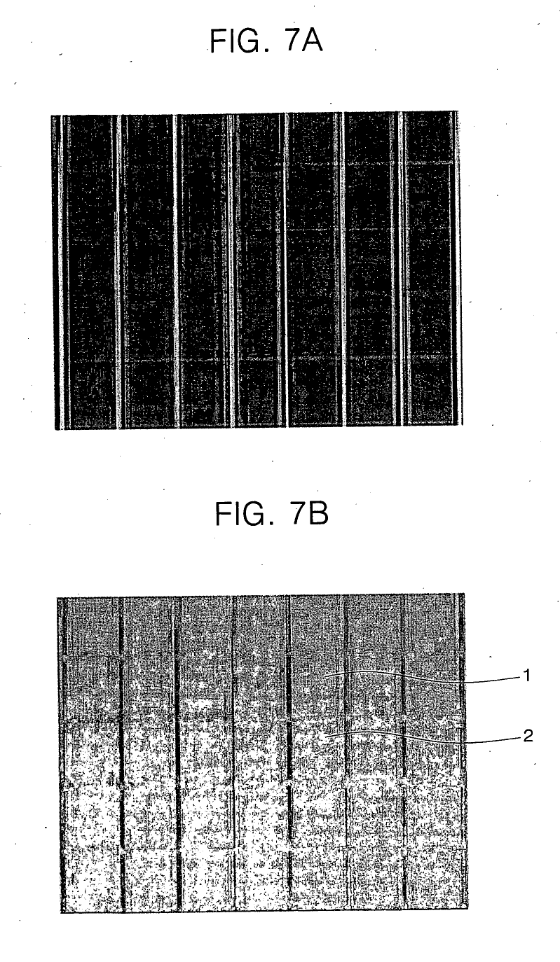

FIG. 7A and FIG. 7B are photographs of state variations of the liquid crystal when a transition pulse wave voltage and a transition DC voltage are applied to the LCD device according to an embodiment of the present invention.

FIG. 7A shows a transition state of the liquid crystal when a transition pulse wave voltage of 6 volts is applied for 0.5 seconds at a frequency of 500 Hz. As shown in FIG. 7A, when the transition pulse wave voltage of 6 volts is applied, the bend transition of the whole liquid crystal of the LCD panel is completed. Even though the transition pulse wave voltage is applied only for 0.5 seconds, it can be applied for 1 second like the usual transition time. That is, the transition time for the transition pulse wave voltage is preferably 0.5 to 1 second. Also, since a Thin Film Transistor (TFT) in the LCD panel 400 is driven at a frequency of 100 Hz, it is preferable for the transition pulse wave voltage to have a frequency in the range of 100-500 Hz.

On the other hand, FIG. 7B shows a transition state of the liquid crystal when a DC voltage of 6 volts is applied for 0.5 seconds. When the DC voltage of 6 volts is applied to the liquid crystal, the whole liquid crystal in the LCD panel progresses as shown in FIG. 7B, in which a portion 1 represents a portion where transition is progressing, and a portion 2 represents a portion where the transition does not progress at all. It can be seen that applying the transition pulse wave voltage causes the bend transition of the liquid crystal to be faster than when applying the constant DC voltage.

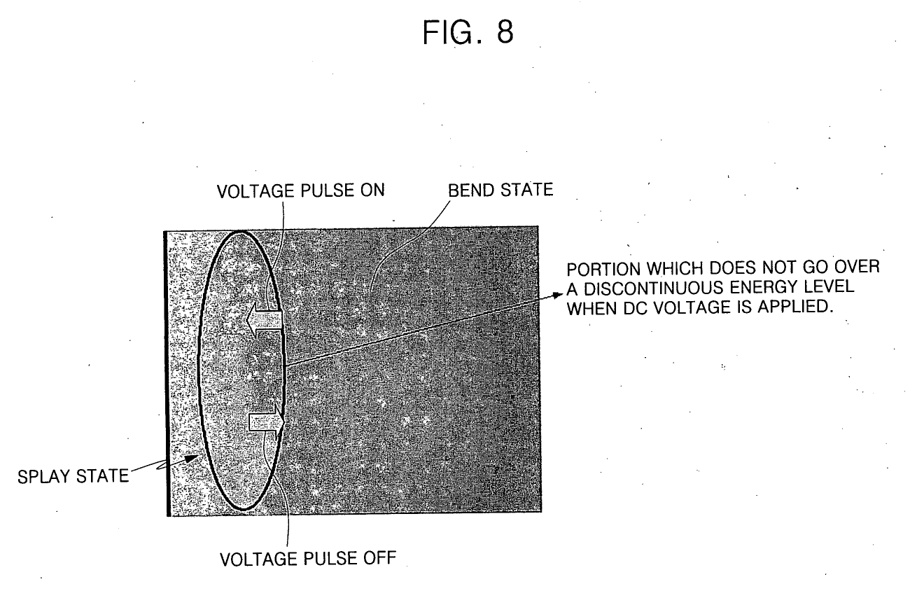

The reason why the bend transition is faster when the pulse wave voltage is applied is explained below with reference to FIG. 8.

FIG. 8 is a photograph of state variations of the liquid crystal according to the application of the transition voltage for the bend transition of the liquid crystal.

Referring to FIG. 8, a gray portion at the left side represents a splay state, a black portion at the right side represents a bend state, and a middle portion represents state variation of the liquid crystal during a voltage pulse and in between pulses when the transition pulse wave voltage is applied.

For the sake of the bend transition in the OCB mode, transition from the splay state to the bend state is performed at more than a predetermined energy level. In order to transition from the splay state to the bend state, it goes over a discontinuous energy section. When a DC voltage is applied to the liquid crystal, a very high transition voltage and long transition time are required to go over the discontinuous energy section. That is why the usual LCD device applies a high DC voltage to the liquid crystal.

When a transition pulse wave voltage is applied, however, an initial transition nucleus is formed as shown in FIG. 8, and then another transition pulse wave voltage is applied at the moment a part of a bend-transitioned portion is restored to the splay state due to the absence of supplied voltage in between pulses. Thus, applying the transition pulse wave voltage is more efficient than applying the DC voltage in consideration of bend growth, and the initial bend transition is possible even at a low voltage.

As described above, when a DC voltage is applied, a high voltage is needed at a bend growth boundary, which is the middle portion of FIG. 8, and growth speed is slow. When a transition pulse wave voltage is applied, discontinuous energy at the boundary is relatively lower than when the DC voltage is applied.

As described above, the LCD device of the present invention can cause a fast bend transition in liquid crystal by applying a transition pulse wave voltage which is as low as 5 to 7 volts across the liquid crystal. Also, since the transition pulse wave voltage is applied by the source driver, there is no need for the usual DC-DC converter used to apply the high voltage. Accordingly, the manufacturing costs and power consumption are reduced.

It will be apparent to those skilled in the art that various modifications and variations can be made in the present invention without departing from the spirit or scope of the present invention. Thus, it is intended that the present invention cover the modifications and variations of this invention provided they come within the scope of the appended claims.

What is claimed is:

1. A Liquid Crystal Display (LCD) device, comprising:
a Liquid Crystal Display (LCD) panel including a plurality of pixel circuits arranged at crossing portions of a plurality of scan lines and a plurality of data lines, each pixel circuit having a Liquid Crystal (LC) capacitor including a common electrode, a pixel electrode, and a liquid crystal;
a scan driver for applying a gate voltage to select the plurality of pixel circuits via the plurality of scan lines;
a source driver for applying a data voltage to the plurality of pixel circuits via the plurality of data lines;
a backlight for for emitting a to the LCD panel;
a backlight controller for applying a backlight voltage to the backlight; and
a timing controller for applying control signals to control the scan driver, the data driver, and the backlight controller;
wherein the source driver applies a transition pulse wave voltage to the plurality of pixel circuits for a predetermined time duration in an initial driving stage.

2. The device of claim 1, wherein the liquid crystal is an Optically Compensated Bend (OCB) liquid crystal.

3. The device of claim 2, wherein the predetermined time duration corresponds to a time needed for the liquid crystal to transition from a splay state to a bend state.

4. The device of claim 3, wherein the predetermined time duration is in the range of 0.5 to 1 second.

5. The device of claim 2, wherein the maximum transition pulse wave voltage is in the range of 5 to 7 volts.

6. The device of claim 5, wherein the minimum transition pulse wave voltage is 0 volts.

7. The device of claim 5, wherein the common electrode is connected to ground.

8. The device of claim 2, wherein the transition pulse wave voltage has a frequency in the range of 100 to 500 Hz.

9. The device of claim 2, wherein the timing controller applies the control signal to the backlight controller to turn off the backlight while the transition pulse wave voltage is being supplied.

10. The device of claim 2, wherein the backlight comprises a red LED, a green LED, and a blue LED adapted to sequentially emit red light, green light, and blue light.

11. The device of claim 2, wherein the backlight comprises a white LED or a Cold Cathode Fluorescent Lamp (CCFL) to emit white light.

12. The device of claim 11, further comprising red, green and blue color filers to filter light emitted from the backlight.

13. The device of claim 2, wherein each pixel circuit comprises:
a switching transistor for transmitting a pulse wave voltage or a data voltage transmitted via the data line to the pixel electrode in response to a selection voltage of the scan line; and
a storage capacitor for storing the pulse wave voltage or the data voltage.

14. A method of driving a Liquid Crystal Display (LCD) device including: a plurality of pixel circuits each having an LC capacitor comprised of a pixel electrode, a common electrode, and a liquid crystal; an LCD panel having the plurality of pixel circuits arranged at crossing points of a plurality of scan lines and a plurality of data lines; a scan driver applying a gate voltage to the plurality of pixel circuits, a source driver applying a data voltage to the plurality of pixel circuits, and a backlight controller applying a driving voltage to a backlight arranged on a rear portion of the LCD panel, the method comprising:
outputting a transition pulse wave voltage from the source driver for a predetermined time duration;
outputting the data voltage from the source driver after the passage of the predetermined duration; and
emitting light of the backlight to the LCD panel.

15. The method of claim 14, wherein the liquid crystal is an Optically Compensated Bend (OCB) liquid crystal.

16. The method of claim 15, wherein the predetermined duration corresponds to a time needed for the liquid crystal to transition from a splay state to a bend state.

17. The method of claim 15, wherein the predetermined time duration is in the range of 0.5 to 1 second.

18. The method of claim 15, wherein the maximum transition pulse wave voltage is in the range of 5 to 7 volts.

19. The method of claim 18, wherein the minimum pulse wave voltage is 0 volts.

20. The method of claim 18, further comprising connecting the common electrode to ground during the outputting of the transition pulse wave voltage from the source driver for the predetermined time duration.

21. The method of claim 15, further comprising the scan driver supplying a gate voltage to the plurality of pixel circuits via the plurality of scan lines during the outputting of the transition pulse wave voltage from the source driver for the predetermined time duration and the outputting of the data voltage from the source driver after the passage of the predetermined duration.

22. The method of claim 15, wherein the transition pulse wave voltage has a frequency in the range of 100 to 500 Hz.

23. The method of claim 15, further comprising the backlight sequentially emitting red light, green light, and blue light with red, green, and blue LEDs.

24. The method of claim 15, further comprising the backlight emitting white light with either a white LED or a cold cathode fluorescent lamp (CCFL).

25. The method of claim 24, further comprising the LCD device filtering light emitted by the backlight with red, green, and blue color filters.

26. The method of claim 15, further comprising:
each pixel circuit for transmitting either a pulse wave voltage or a data voltage transmitted through the data line to the pixel electrode in response to a selection voltage of the scan line; and
storing the pulse wave voltage or the data voltage.
